(19) United States
(12) Patent Application Publication
(10) Pub. No.: US 2015/0019109 A1
(43) Pub. Date: Jan. 15, 2015

(54) Method and device for controlling an internal combustion engine

(71) Applicants: Alexander TROFIMOV, Ludwigsburg (DE); Martin FRIEDRICH, Stuttgart (DE); Matthias WEINMANN, Balingen (DE); Norbert MUELLER, Ludwigsburg (DE); Karthik RAI, Stuttgart (DE); Jason SCHWANKE, Novi, MI (US)

(72) Inventors: Alexander TROFIMOV, Ludwigsburg (DE); Martin FRIEDRICH, Stuttgart (DE); Matthias WEINMANN, Balingen (DE); Norbert MUELLER, Ludwigsburg (DE); Karthik RAI, Stuttgart (DE); Jason SCHWANKE, Novi, MI (US)

(73) Assignee: Robert Bosch GmbH, Stuttgart (DE)

(21) Appl. No.: 14/331,847

(22) Filed: Jul. 15, 2014

(30) Foreign Application Priority Data
Jul. 15, 2013 (DE) 10 2013 213 784.2
Sep. 2, 2013 (DE) 10 2013 217 433.0
Mar. 6, 2014 (DE) 10 2014 204 086.8

(51) Int. Cl. F02N 19/00; F02D 41/00

(52) U.S. Cl. CPC F02N 19/005; F02D 41/0005; F02N 2019/008
USPC 701/102

(57) ABSTRACT

In a method for controlling the stopping behavior of an internal combustion engine, after a stop request, an air metering device initially reduces the volume of air supplied to the internal combustion engine during the stop and subsequently increases this volume of air again at an opening crankshaft angle (KWopen), the opening crankshaft angle (KWopen) being oriented to an undercut crankshaft angle (KWlow), at which a speed (n) of the internal combustion engine when stopping drops below a predefinable speed threshold value (ns). The time characteristic of the speed (n) of the internal combustion engine after the stop request is influenced in such a way that the internal combustion engine comes to a halt in a predefinable target crankshaft angle range.

### BACKGROUND OF THE INVENTION

1. Field of the Invention

The present invention relates to a method and a device for controlling the stopping behavior of an internal combustion engine.

2. Description of the Related Art

A method for stopping an internal combustion engine is known from published German patent application document DE 10 2011 082 198 A1, in which the volume of air supplied to the internal combustion engine via an air metering device is reduced after a stop request has been ascertained, the volume of air supplied to the internal combustion engine via the air metering device being increased again when a detected speed of the internal combustion engine falls below a predefinable threshold, an intake cylinder to which the volume of air is supplied no longer entering a power stroke after the volume of air is increased.

### BRIEF SUMMARY OF THE INVENTION

According to a first specific embodiment of the present invention, it is provided that in a method for controlling the stopping behavior of an internal combustion engine in which, after a stop request, an air metering device, in particular a throttle flap or a variable valve adjustment, initially reduces the volume of air supplied to the internal combustion engine during the stopping procedure, and increases this volume of air again at an opening crankshaft angle, the opening crankshaft angle being oriented to an undercut crankshaft angle at which the speed of the internal combustion engine during the stop falls below a predefinable speed threshold value, and the time characteristic of the speed of the internal combustion engine being influenced after the stop request and before the opening crankshaft angle in such a way that the internal combustion engine comes to a halt in a predefinable target crankshaft angle range. Compared to the related art, this has the advantage that the stopping behavior of the internal combustion engine may be particularly well controlled. In particular, it is possible to determine which cylinder of the internal combustion engine is in the compression stroke when the stop is complete, that is, when the internal combustion engine has transitioned to a halt.

The speed profile in this case is influenced by an auxiliary unit, which directly or indirectly applies a torque to the crankshaft which brakes or accelerates the rotational movement of the crankshaft.

In one advantageous refinement, the speed profile of the internal combustion engine is influenced in such a way that a speed gradient is set to a predefinable target speed gradient as the internal combustion engine is stopping. The speed gradient is understood herein to mean the change of speed of the internal combustion engine per unit of time during a characteristic interval, for example, between two (for example, but not necessarily) successive top dead center positions of cylinders of the internal combustion engine.

In one advantageous refinement, the speed gradient is set by changing the actuation of a high pressure injection pump coupled to the crankshaft after the stop request, particularly preferably during the stopping of the internal combustion engine. Actuating the high pressure injection pump changes the torque transmitted to the crankshaft, and this allows the speed gradient to be set in a simple manner.

The use of the high pressure injection pump is particularly advantageous because the piston of the high pressure injection pump carries out an up and down movement and thus carries out intake strokes and compression strokes in a known manner. In the intake stroke, the piston moves downward and fuel is drawn in from a line on the low pressure side. In the compression stroke, the piston moves upward and fuel is conveyed into a high pressure injection pump which consumes energy and therefore slows down the rotation of the crankshaft. This movement of the piston occurs in a known manner via a cam on the camshaft. The rotational movement of the camshaft is coupled in a known manner to the rotational movement of the crankshaft. At a point in time of swing back of the crankshaft, the direction of rotation of the camshaft is also reversed. If at this point in time the piston of the high pressure pump is in the intake stroke, then the reversal of the direction of rotation causes the high pressure pump to enter a compression stroke, such that rotation energy is destroyed (or restored in the high pressure rail). This makes it possible for rotation energy to be destroyed at any time near the reversal point of the direction of rotation, which effectively slows down the rotational movement of the internal combustion engine.

In another advantageous refinement it is possible, as an alternative to or in addition to actuating the high pressure injection pump, to actuate an oil pump coupled to the crankshaft and/or a cooling water pump in order in this way to alter the speed gradient during the stop.

In another advantageous refinement, it is possible, as an alternative to or in addition to actuating the high pressure injection pump, to change an actuation of an electric machine coupled to the crankshaft after the stop request, in particular during the stopping of the internal combustion engine. Actuation of the electric machine may change the torque transmitted to the crankshaft, thus allowing the speed gradient to be adjusted in a particularly simple manner. The electric machine in this case may be a generator, or an electric motor, or another electric machine, for example, a belt-driven starter generator.

In another advantageous specific embodiment, it is alternatively or additionally possible to change the actuation of a compressor in an air conditioning unit coupled to the crankshaft after the stop request, in particular during the stopping of the internal combustion engine. Here, too, it is possible to vary, in a simple manner, the torque transmitted to the crankshaft, and so set the speed gradient.

In another advantageous specific embodiment of the present invention, it may be provided that the time characteristic of the speed of the internal combustion engine is influenced in such a way that the speed of the internal combustion engine, when the top dead center position following the undercut crankshaft angle is reached, i.e., at the crankshaft angle at which the next piston of the internal combustion engine passes through its top dead center position after the undercut crankshaft angle, accepts a predefinable target speed value. By controlling the speed at this crankshaft angle, it is possible to control the stopping behavior of the internal combustion engine in a particularly simple manner.

In another advantageous specific embodiment of the present invention, it is provided that a cylinder is ascertained, in which a final fuel-air mixture is to be ignited before the internal combustion engine begins to stop, and after the stop request and before the onset of the stop following ignition of the fuel-air mixture in this cylinder, the ignition is switched off. This means that the cylinder is ascertained, after the ignition of which no further ignition takes place in any cylinder of the internal combustion engine, thus initiating the stopping of the internal combustion engine. By specifically selecting this cylinder in which the final ignition is to occur, it is possible to determine in a particularly simple manner the cylinder which is in the compression stroke at the end of the stopping of the internal combustion engine.

According to another aspect of the present invention, the time characteristic of the speed is influenced as a function of an inducted volume of air of a cylinder to which the increased volume of air is supplied. In particular, the time characteristic of the speed may be influenced in such a way that the speed is reduced when the inducted volume of air exceeds a definable air volume threshold value. The inducted volume of air may, for example, be ascertained by a predictive method, for example, via an engine characteristics map as a function of the speed existing at the undercut crankshaft angle.

It has been found that a volume of air that has been increased too much results in part in excessive swing back, and therefore in a jerking perceived by the driver and sensed as uncomfortable. Such jerking may be effectively suppressed with the aid of the aforementioned measures.

In another aspect, the present invention includes a computer program which is programmed in such a way that it carries out all steps of a method according to the present invention when it is executed.

In another aspect, the present invention includes an electric storage medium for a control device and/or regulating device of the internal combustion engine, on which the computer program is stored.

In another aspect, the present invention includes the control device and/or regulating device of the internal combustion engine, which is programmed in such a way, for example, with the computer program, that it is able to carry out all steps of a method according to the present invention.

### BRIEF DESCRIPTION OF THE DRAWINGS

FIG. 1 shows an internal combustion engine.

FIG. 2 shows the progress of characteristic variables of the internal combustion engine, when stopping.

FIG. 3 shows a frequency distribution of the stopping crankshaft angle in one specific embodiment of the present invention and in a method according to the related art.

FIG. 4 shows the time characteristic of the speed in one specific embodiment of the present invention.

FIG. 5 shows the time characteristic of the speed in another specific embodiment of the present invention.

FIG. 6 shows the time characteristic of the speed in another specific embodiment of the present invention.

FIG. 7 shows the characteristic relationships between the undercut speed and the stopping crankshaft angle.

FIG. 8 shows the characteristic connection between the speeds at different top dead center positions during the stop.

FIG. 9 shows the time characteristic of the speed in additional specific embodiments of the present invention.

### DETAILED DESCRIPTION OF THE INVENTION

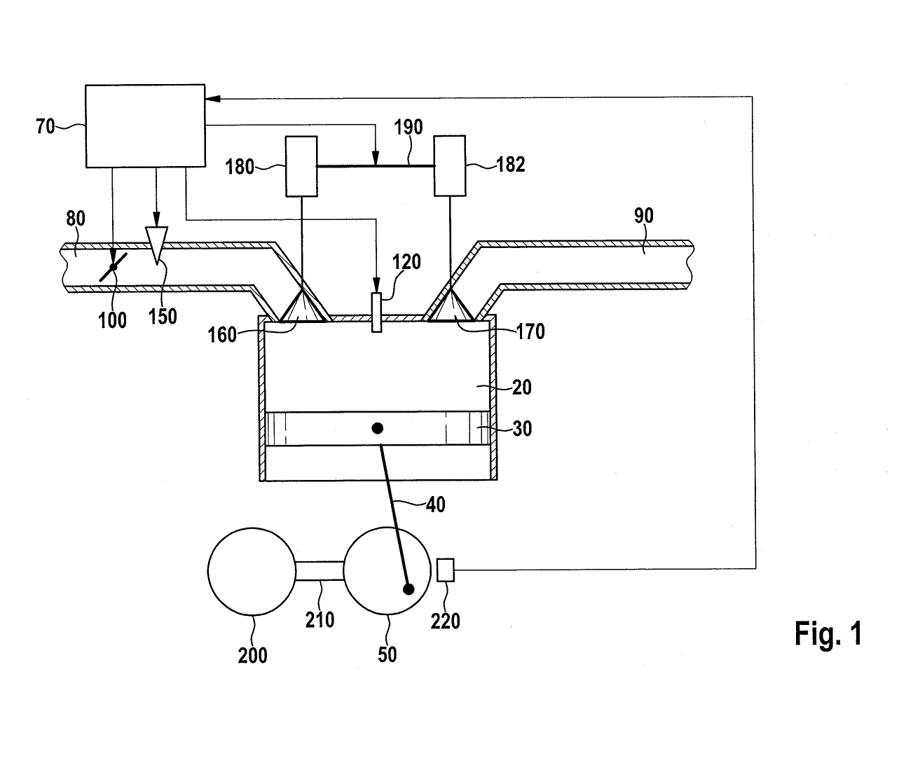

FIG. 1 schematically represents the design of an internal combustion engine 10. This internal combustion engine 10 has a combustion chamber 20, the volume of which is restricted by a piston 30 which is coupled via a connecting rod 40 to a crankshaft 50, and which carries out an up and down movement in a characteristic manner when the crankshaft is rotated. A control unit (i.e., a control device and/or regulating device) controls various actuating elements of internal combustion engine 10 in a known manner, for example, a throttle flap 100, an injection valve 150, a spark plug 120 and, if necessary, the up and down movement of an inlet valve 160, which is linked via a first cam 180 to a camshaft 190, and/or the up and down movement of an outlet valve 170 which is coupled via a second cam 182 to camshaft 190. Various devices for controlling the movement of inlet valve 160 and/or outlet valve 170 may be provided in a known manner in the internal combustion engine, for example, a variable cam adjustment or a fully variable, for example, electrohydraulic, valve adjustment.

Air is inducted in a known manner through an intake pipe 80 and expelled through an exhaust pipe 90. In the exemplary embodiment shown in FIG. 1, injection valve 150 is situated in intake pipe 80. It is also possible, however, for injection valve 150 to inject directly into combustion chamber 20 in a known manner.

Crankshaft 50 is connected via a mechanical coupling 210 to an electric machine 200. Electric machine 200 may, for example, be a generator or, for example, a starter generator. It is also possible for electric machine 200 to be a conventional starter and for mechanical coupling 210 to include a ring gear and a pinion used to mesh the starter. A crankshaft angle sensor 220 may be provided in order to detect the angular position of crankshaft 50, and to communicate it, for example, to control unit 70. However, it is also possible, for example, for the angular position to be ascertained mathematically, without a crankshaft angle sensor 220, for example.

A high pressure pump which conveys fuel to injection valve 150, for example, via an injection rail, may be provided in particular when injection valve 150 injects directly into combustion chamber 20. This high pressure injection pump is connected to crankshaft 50.

A compressor from an air conditioning unit may also be provided, which is coupled to crankshaft 50. The high pressure injection pump and/or the compressor in the air conditioning unit may be actuated, for example, by control unit 70. It is also possible for an oil pump and/or a cooling water pump to be coupled to crankshaft 50.

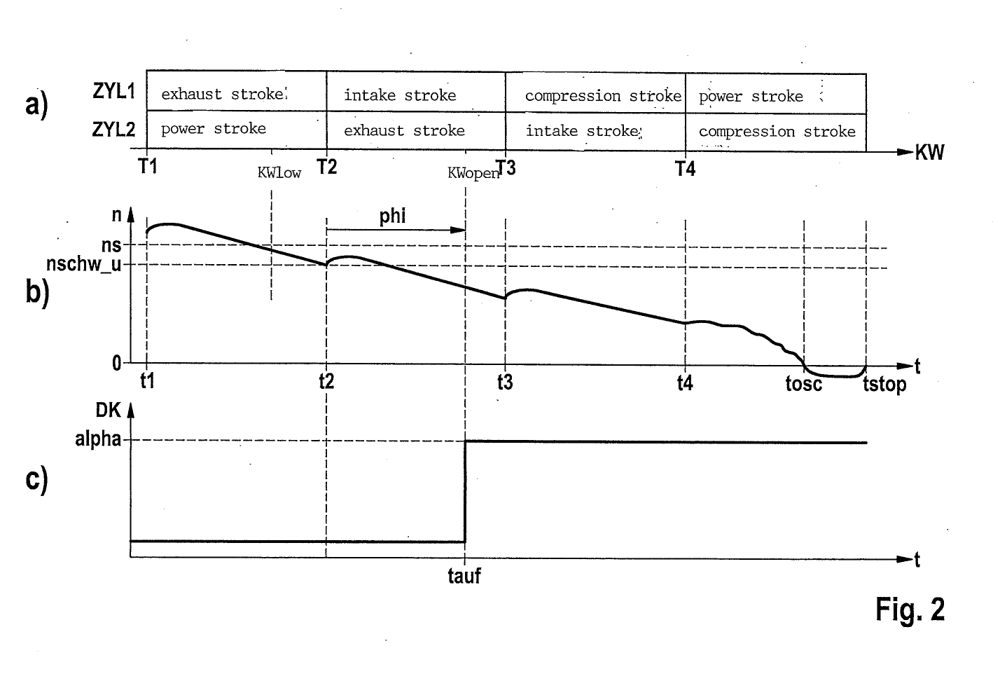

FIG. 2 represents the behavior of internal combustion engine 10 during the stop. The stop begins after a stop request is made. This may be issued by the driver, for example, or for example, also by a start-stop control.

FIG. 2a) represents the stroke sequence of a first cylinder ZYL1 and of a second cylinder ZYL2 of internal combustion engine 10 as a function of crankshaft angle KW. At a first dead center position T1, first cylinder ZYL1 enters its exhaust stroke and second cylinder ZYL2 enters its power stroke. At a second dead center position T2, first cylinder ZYL1 enters its intake stroke and second cylinder ZYL2 enters its exhaust stroke. At a third dead center position T3, first cylinder ZYL1 enters its compression stroke and second cylinder ZYL2 enters its intake stroke. At a fourth dead center position T4, first cylinder ZYL1 enters its power stroke and second cylinder ZYL2 enters its compression stroke.

FIG. 2b) shows the profile of speed n of the internal combustion engine over time t. The time axis of FIG. 2b) is parallel to the crankshaft angle of FIG. 2a). A first point in time t1 corresponds to the first dead center position T1, a second point in time t2 corresponds to second dead center position T2, a third point in time t3 corresponds to the third dead center position T3 and a fourth point in time t4 corresponds to fourth dead center position T4. Similarly, FIG. 2c) includes a time axis, in this case the degree of opening DK of throttle flap 100 being plotted over time t. Since speed n of the internal combustion engine drops at time t, the time axis in both of these graphs is non-linear.

At the beginning of the stop, throttle flap 100 is at least partly closed in order to make the stopping behavior of internal combustion engine 10 more comfortable.

At an undercut crankshaft angle KWlow, speed n of the internal combustion engine remains below a predefinable speed threshold value ns. At characteristic points in time, for example, at each dead center, it is checked whether speed n of the internal combustion engine has fallen below the predefinable speed threshold value ns. In the exemplary embodiment shown in FIG. 2b) this occurs for the first time at second dead center position T2 at second point in time t2. Speed n of the internal combustion engine ascertained at this point in time is undercut speed nschw_u. At a difference-speed angle phi after second dead center position T2, at which it has been initially determined that speed n of the internal combustion engine has fallen below the predefinable speed threshold value, the degree of opening DK of throttle flap 100 is raised to an increased degree of opening alpha relative to an opening crankshaft angle KWopen or to opening point in time topen. The throttle flap is essentially closed up to an opening point in time topen during the stopping of the internal combustion engine. As a result, first cylinder ZYL1 has inducted little air in its intake stroke, whereas second cylinder ZYL2, which enters its intake stroke only after the degree of opening of throttle flap DK is increased, inducts a larger volume of air. After fourth dead center position T4, first cylinder ZYL1 is in its power stroke, i.e., the volume of gas stored in it which is compressed in the compression stroke, now acts as an expanding gas spring on piston 30. Air in second cylinder ZYL2 also acts as a gas spring on piston 30, but in the opposite direction. Since the air spring in second cylinder ZYL2 is stronger than the air spring in first cylinder ZYL1, the internal combustion engine is strongly decelerated after fourth dead center position T4, speed n of the internal combustion engine drops to a swing back point in time toss below zero, the internal combustion engine swings back and finally comes to a halt at a stop point in time tstop.

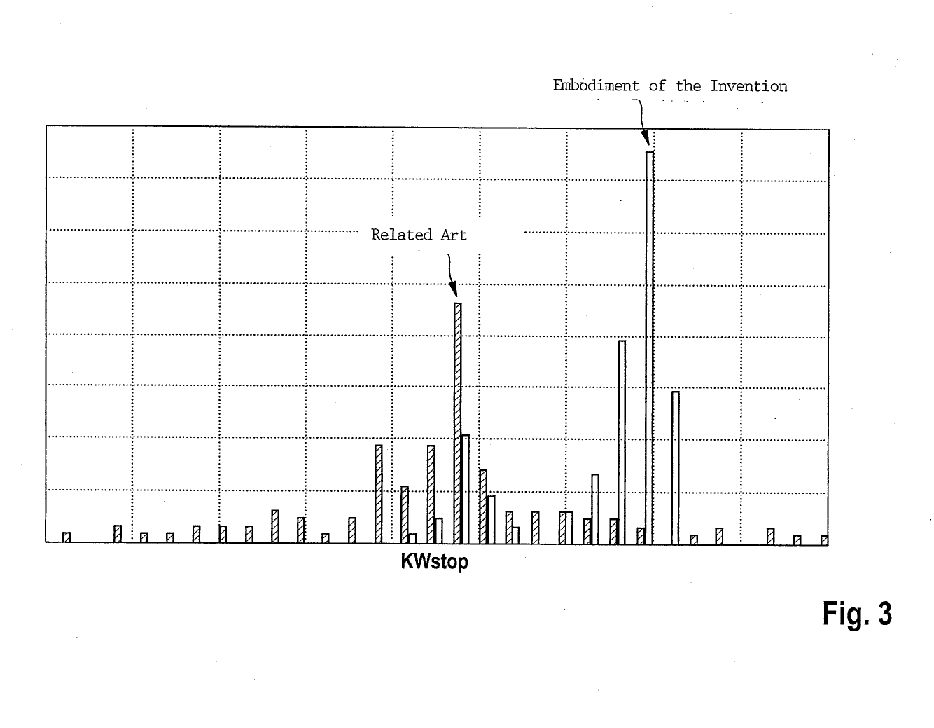

FIG. 3 shows a stop crankshaft angle KWstop, at which the internal combustion engine comes to a halt at stopping point in time tstop. Represented in FIG. 3 is a frequency distribution of the stopping crankshaft angles according to a method known from the related art, and in conjunction with a specific embodiment according to the present invention. As is apparent, the stopping position of the internal combustion engine may be significantly better controlled with the method according to the present invention, and it is possible to achieve stopping crankshaft angle KWstop within a target crankshaft angle range. For example, it is possible for stopping crankshaft angle KWstop to lie at a crankshaft angle in a range of 90° to 150° before the next dead center position.

The cylinder which is in its compression stroke when internal combustion engine 10 has completely stopped (this is second cylinder ZYL2 in the example shown in FIG. 2), may be predicted at the onset of the stop. It may, for example, be ascertained as a function of speed n of internal combustion engine 10 when the injection of fuel is switched off (this is also referred to as the onset of the stop of internal combustion engine 10), as a function of the cylinder in which the fuel-air mixture was last ignited, and as a function of a speed gradient, that is, the temporal change of speed n of internal combustion engine 10 in time, for example, between two successive dead center positions.

The heavier the crankshaft 50 is (including the dual-mass flywheel), the longer it takes for the internal combustion engine to stop, because the speed gradient is a function of the energy losses resulting from friction and of the spin of the internal combustion engine. For this reason, stronger friction results in a shorter stop, and less friction in a longer stop. While the spin of the internal combustion engine is essentially constant, the friction of internal combustion engine 10 may vary with time, and depends strongly on the temperature of internal combustion engine 10. In typical applications, in which internal combustion engine 10 is stopped and restarted, internal combustion engine 10 is warm, and friction may therefore be considered as constant over time. Thus, the speed gradient of a warm internal combustion engine does not change much over time. It is therefore possible to predict the cylinder which is in its compression stroke when internal combustion engine 10 has come to a halt, for example, with the aid of engine characteristics maps or using a mathematical function based on speed n of internal combustion engine 10 at the point in time at which the fuel injection was switched off, of the cylinder in which a fuel-air mixture was last ignited, and of the speed gradient.

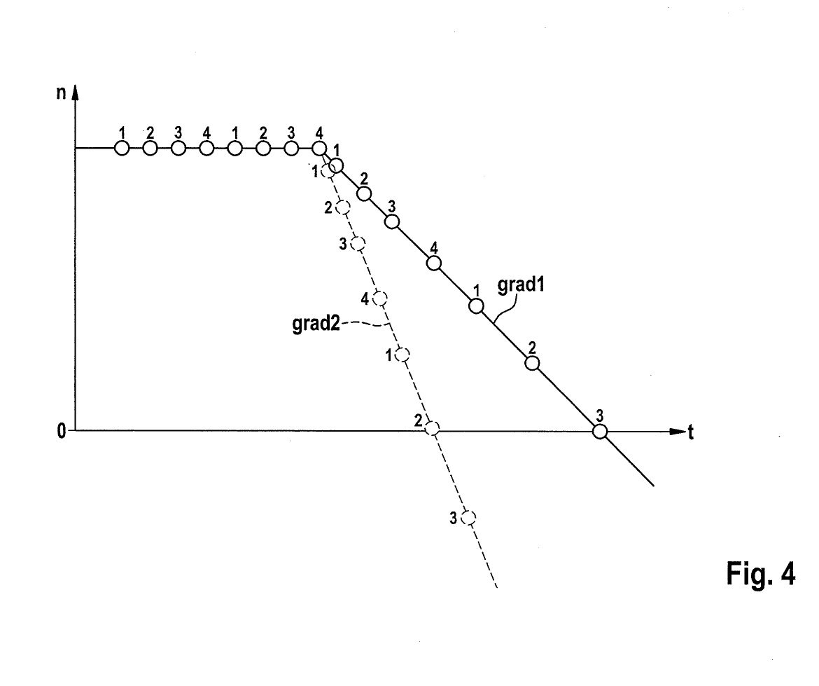

This is illustrated in FIG. 4. Here, speed n of internal combustion engine 10 is plotted over time t. The example shown here is a four-cylinder internal combustion engine 10. It is understood that the method may be expanded to include any number of cylinders. The cylinders of internal combustion engine 10 are fired successively in the firing order one, two, three, four during running operation. After a stop request (for example, when requested by the driver or, for example, an automatic start-stop device) is ascertained, internal combustion engine 10 is switched off. Cylinder four is the last cylinder in which the fuel-air mixture is ignited. FIG. 4 shows the example of stopping in which speed n is temporally changed at a first speed gradient grad1. It may be ascertained that the third cylinder is in its compression stroke at the point in time at which speed n drops to zero, i.e., at which time the internal combustion engine has come to a halt. If, for example, it is desired that the second cylinder is in its compression stroke at the end of the stop, it may be provided in a first specific embodiment of the present invention that the speed gradient is changed to a second speed gradient grad2. In this case second speed gradient grad2 is selected so that, as shown in FIG. 4, the second cylinder is in its compression stroke when internal combustion engine 10 has come to a halt.

There are multiple options for influencing the speed gradient: for example, it is possible to increase the speed gradient by activating the high pressure injection pump, for example, at the onset of the stop of internal combustion engine 10. It is possible, for example, to maximize the pressure in an injection rail. This increases the friction on the camshaft and, because the camshaft is coupled to the crankshaft, also indirectly the friction on the crankshaft.

An additional or alternative option for increasing the speed gradient lies in the targeted actuation of electric machine 200. A further or additional option of increasing the speed gradient lies in the targeted actuation of the compressor in the air conditioning unit.

In such a case, a provision may be made to predefine the required speed gradient depending on the cylinder which last fired, and then set the speed gradient in accordance with one or more of the above-mentioned options. It is understood that the method is not limited to a particular cylinder being in its compression stroke when the internal combustion engine comes to a halt. It is also possible, for example, to specify which cylinder is in its intake stroke when internal combustion engine 10 comes to a halt.

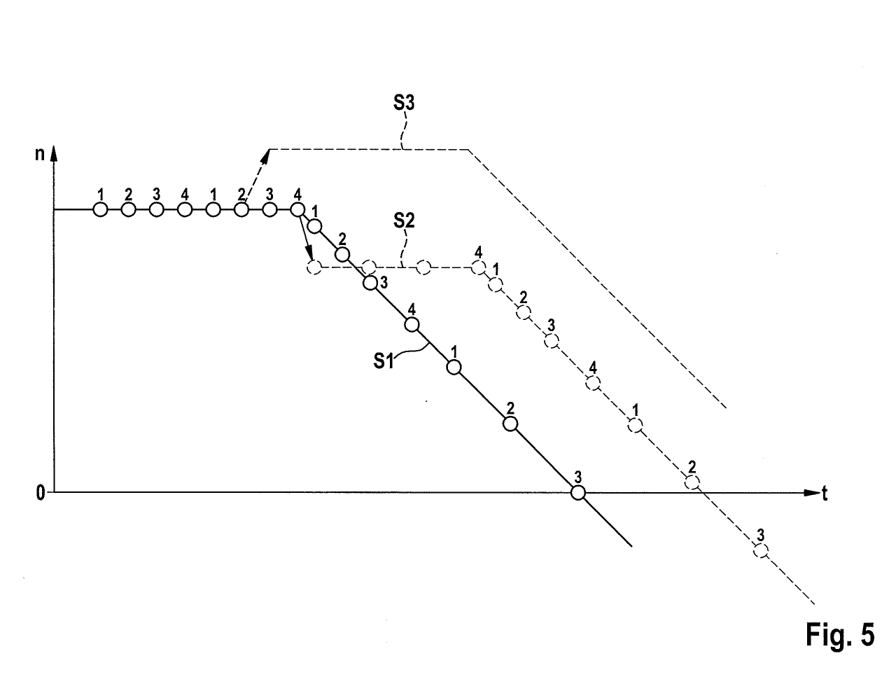

FIG. 5 shows another exemplary embodiment of the present invention. Shown here is the profile of speed n of the internal combustion engine over time t. As in FIG. 4, this indicates which cylinder is in its compression stroke.

According to a first strategy S1, the stopping of internal combustion engine 10 begins after the firing of the fourth cylinder and the internal combustion engine stops with the third cylinder in the compression stroke. According to a second strategy S2, speed n of internal combustion engine 10 changes before the onset of the stop, for example, by actuating electric machine 200. According to second strategy S2, the speed of internal combustion engine 10 is reduced, thereby achieving that by correctly choosing speed n at the onset of the stop, the second cylinder, rather than the third cylinder, is in the compression stroke when internal combustion engine 10 comes to a halt. Alternatively, it is also possible according to a third strategy S3 to accelerate internal combustion engine 10 before the onset of the stop.

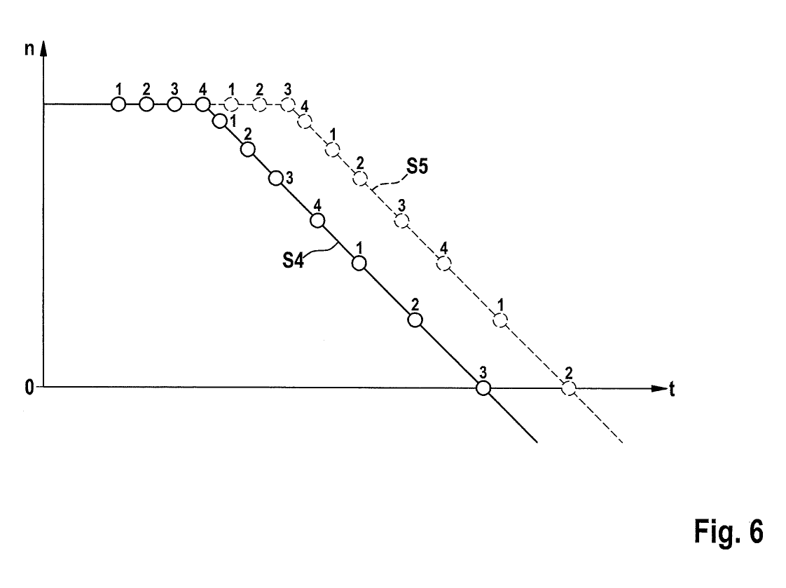

FIG. 6 shows additional specific embodiments of the present invention. Again, speed n of the internal combustion engine is represented over time t. According to a fourth strategy S4, the fourth cylinder is fired last before the onset of the stop, and internal combustion engine 10 comes to a halt with the third cylinder in the compression stroke. According to a fifth strategy S5, it is possible to vary the cylinder which is last fired before the onset of the stop, namely so that the desired cylinder, in this case the second cylinder, is in the compression stroke when the internal combustion engine has come to a halt. In the example shown herein, it is ascertained that internal combustion engine 10 comes to a halt in the desired cylinder when the cylinder which has last fired is the third cylinder. Thus, the firing and injection are maintained until the third cylinder has fired, and the stop subsequently begins.

It is understood that the aforementioned methods of varying the speed gradient, speed n of internal combustion engine 10 at the onset of the stop and the cylinder which last fired before the onset of the stop, may be combined with one another.

In a particularly advantageous specific embodiment of the present invention, internal combustion engine 10 is switched off in such a way that the gaps in the speed sensor wheel that are important for synchronizing internal combustion engine 10 are just in front of crankshaft angle sensor 220 when the internal combustion engine has come to a halt, so that the crankshaft angle of internal combustion engine 10 may be quickly detected upon a restart of internal combustion engine 10, which accelerates synchronization and therefore the entire starting process.

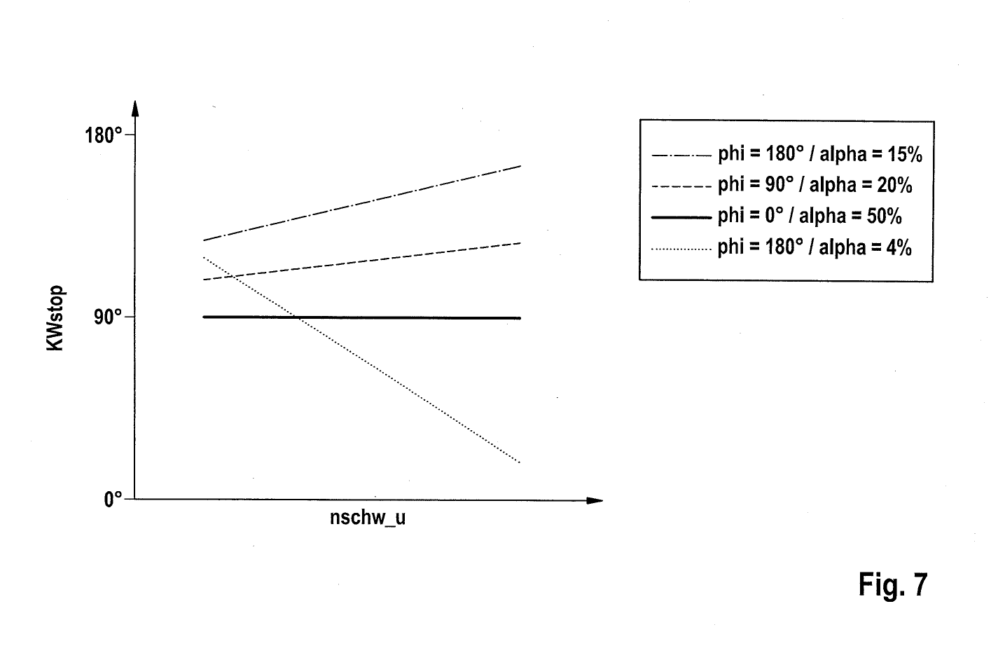

FIG. 7 illustrates stopping crankshaft angle KWstop as a function of undercut speed nschw_u. Shown are the characteristic connections for various combinations of the difference speed angle phi and of the increased degree of opening alpha. As is apparent, stopping crankshaft angle KWstop may be predefined by an appropriate choice of the difference speed angle phi and/or of the increased degree of opening alpha and/or of undercut speed nschw_u. This choice of difference speed angle phi and/or of the increased degree of opening alpha and/or of undercut speed nschw_u may be combined in a particularly advantageous manner with one or more of the aforementioned exemplary embodiments, so that not only is the cylinder determined which is in its compression stroke when internal combustion engine 10 has come to a halt, but also its precise angular position.

If undercut speed nschw_u is not specifically predefined, it is clear from FIG. 7 that, depending on the combination of difference speed angle phi and increased degree of opening alpha, a range of stopping crankshaft angles KWstop is possible in which the internal combustion engine comes to a halt. According to another specific embodiment of the present invention, it may be provided to select difference speed angle phi and increased degree of opening alpha in such a way that stopping crankshaft angle KWstop lies in a predefinable target crankshaft angle range. The difference speed angle phi and the increased degree of opening alpha are particularly advantageously selected so that stopping crankshaft angle KWstop lies in the target crankshaft angle range within a broad as possible range of undercut speed nschw_u.

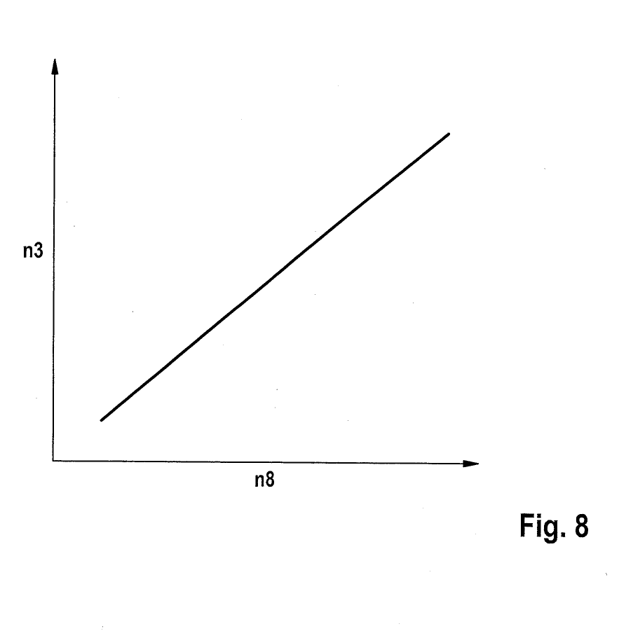

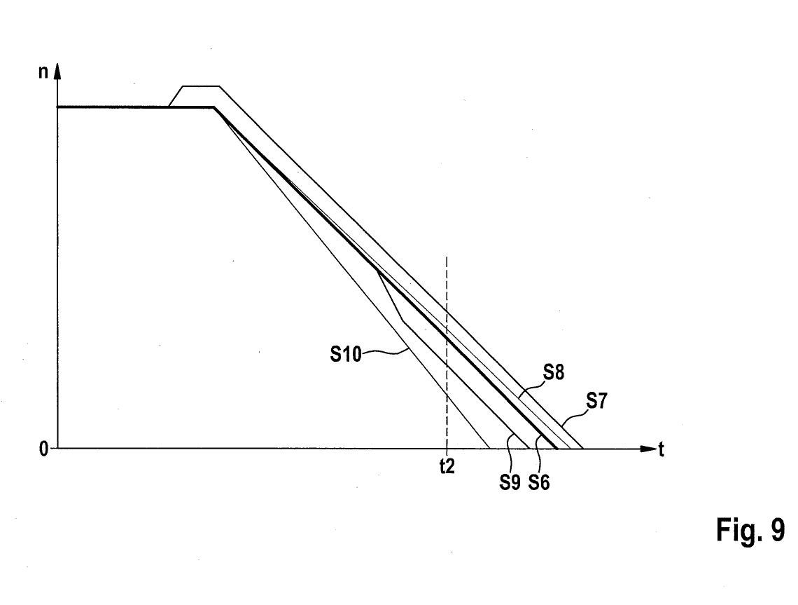

According to another specific embodiment of the present invention, undercut speed nschw_u is determined such that stopping crankshaft angle KWstop lies as certainly as possible in the predefinable target crankshaft angle range. For this purpose, it may be provided that undercut speed nschw_u is predicted during the stopping of internal combustion engine 10. This may be achieved, for example, by a mathematical model or by a characteristic curve. An example of such a characteristic curve is shown in FIG. 8. Shown here is speed n8 in the eighth-last dead center position of internal combustion engine 10 and its connection to speed n3 in the third-last dead center position of internal combustion engine 10. It is apparent that a characteristic connection exists between these speeds. Additional specific embodiments of the present invention are shown in FIG. 9. Shown here is speed n of internal combustion engine 10 over time t. For purposes of clarification, the representation of FIG. 9 is oriented by way of example to the representation in FIG. 2, i.e., at second point in time t2 it is established for the first time that speed n has fallen below predefinable speed threshold value ns, i.e., at second point in time t2 speed n is equal to undercut speed nschw_u. According to a sixth strategy S6, the time characteristic of speed n is not influenced by additional measures, since undercut speed nschw_u lies within the target range. According to a seventh strategy S7, the response thereto may be that it is determined that undercut speed nschw_u is too low. By predicting the profile of speed n it is determined after the stop request that undercut speed n nschw_u is too low, and even before the onset of the stop, speed n of the internal combustion engine is increased, as described above, and the point in time of the last combustion is delayed so that undercut speed nschw_u lies within the target range. The eighth strategy S8 illustrates additional measures for achieving this: in this case, speed n of internal combustion engine 10 is reduced before the onset of the stop, and the onset of the stop is delayed as well. It is understood that the actions of increasing/reducing the speed before the onset of the stop and the postponement of the onset of the stop are two measures which may be used independently of one another.

As an additional or supplemental measure, it may be provided according to a ninth strategy S9 to change the speed gradient during the stopping of the internal combustion engine, in the example shown here, briefly increasing it, then reducing it again so that undercut speed nschw_u lies within the target range. According to a tenth strategy S10, it may also be provided to change the speed gradient so that it assumes an altered value during the entire stop. It is understood that this tenth strategy S10 may also be arbitrarily combined with the above mentioned strategies or with some of them.

The present invention is not limited to the exemplary embodiments. As previously mentioned, the present invention may be used in internal combustion engines having any number of cylinders. The method according to the present invention may be carried out in control unit 70 or in an additional control unit. It is not essential for the metering of the volume of air supplied to the internal combustion engine to be regulated by throttle flap 100. For example, a corresponding effect may also be achieved with a variable valve adjustment.

The means for changing the speed gradient are not limited to the means shown above. In principle, all components may be considered with which a torque may be applied to crankshaft 50, for example, even an oil pump and/or a cooling water pump, and/or injection and/or combustion of fuel in one or more cylinders.

What is claimed is:

1. A method for controlling a stopping behavior of an internal combustion engine after a stop request, comprising:
initially reducing, by an air metering device, a volume of air supplied to the internal combustion engine during the stop; and
subsequently increasing the volume of air supplied to the internal combustion engine at an opening crankshaft angle, wherein the opening crankshaft angle is oriented to an undercut crankshaft angle at which a speed of the internal combustion engine when stopping drops below a predefined speed threshold value, and wherein the time characteristic of the speed of the internal combustion engine is influenced after the stop request and before the opening crankshaft angle in such a way that the internal combustion engine comes to a halt in a predefined target crankshaft angle range.

2. The method as recited in claim 1, wherein the time characteristic of speed of the internal combustion engine is influenced in such a way that a speed gradient is set to a predefined target speed gradient during the stopping of the internal combustion engine.

3. The method as recited in claim 2, wherein an actuation of a high pressure injection pump coupled to the crankshaft is changed during the stopping of the internal combustion engine following the stop request.

4. The method as recited in claim 3, wherein an actuation of an electric machine coupled to the crankshaft is changed during the stopping of the internal combustion engine following the stop request.

5. The method as recited in claim 2, wherein an actuation of at least one of (i) a compressor in an air conditioning unit, (ii) an oil pump, and (iii) a cooling water pump coupled to the crankshaft is changed during the stopping of the internal combustion engine following the stop request.

6. The method as recited in claim 3, wherein the time characteristic of the speed of the internal combustion engine is influenced in such a way that the speed of the internal combustion engine assumes a predefined target speed value when reaching the top dead center position following the undercut crankshaft angle.

7. The method as recited in claim 2, wherein a target cylinder in which a last fuel/air mixture is to be ignited before the onset of the stop of the internal combustion engine is ascertained, and the ignition is switched off after the stopping request and before the onset of the stop following the ignition of the fuel/air mixture in the target cylinder.

8. The method as recited in claim 2, wherein the influencing of the time characteristic of the speed of the internal combustion engine is selected as a function of an inducted volume of air of a cylinder to which the increased volume of air is supplied.

9. The method as recited in claim 8, wherein the influencing of the time characteristic of the speed of the internal combustion engine is achieved by reducing the speed when the inducted volume of air exceeds a defined air volume threshold.

10. A non-transitory, computer-readable data storage medium storing a computer program having program codes which, when executed on a computer, perform a method for controlling a stopping behavior of an internal combustion engine after a stop request, the method comprising:
initially reducing, by an air metering device, a volume of air supplied to the internal combustion engine during the stop; and
subsequently increasing the volume of air supplied to the internal combustion engine at an opening crankshaft angle, wherein the opening crankshaft angle is oriented to an undercut crankshaft angle at which a speed of the internal combustion engine when stopping drops below a predefined speed threshold value, and wherein the time characteristic of the speed of the internal combustion engine is influenced after the stop request and before the opening crankshaft angle in such a way that the internal combustion engine comes to a halt in a predefined target crankshaft angle range.

11. A control device of an internal combustion engine for controlling a stopping behavior of the internal combustion engine after a stop request, comprising:
a controller including a processor, wherein the controller is configured to:
initially reduce, by an air metering device, a volume of air supplied to the internal combustion engine during the stop; and
subsequently increase the volume of air supplied to the internal combustion engine at an opening crankshaft angle, wherein the opening crankshaft angle is oriented to an undercut crankshaft angle at which a speed of the internal combustion engine when stopping drops below a predefined speed threshold value, and wherein the time characteristic of the speed of the internal combustion engine is influenced after the stop request and before the opening crankshaft angle in such a way that the internal combustion engine comes to a halt in a predefined target crankshaft angle range.
